(19) United States
(12) Patent Application Publication
(10) Pub. No.: US 2012/0255827 A1
(43) Pub. Date: Oct. 11, 2012

(54) Drive System of the Engine Cooling System for Motor Vehicles

(75) Inventor: Matthias LECHNER, Nurnberg (DE)

(73) Assignee: MAN Truck & Bus AG, Muenchen (DE)

(21) Appl. No.: 13/440,651

(22) Filed: Apr. 5, 2012

(30) Foreign Application Priority Data
Apr. 6, 2011 (DE) 10 2011 016 204.6

(51) Int. Cl. F16D 35/00; F16D 127/00

(52) U.S. Cl. 192/58.4

(57) ABSTRACT

In a motor vehicle having a radiator for cooling a cooling medium and a fan driven by a driveshaft of an internal combustion engine, the fan being arranged between the radiator and the internal combustion engine, a drive system for the fan has a viscous coupling and a vibration damper, which includes an elastic element and which dampens and/or decouples the vibrations between the driveshaft-side output of the internal combustion engine and the fan. The viscous coupling and the vibration damper are arranged between the internal combustion engine and the fan, wherein the vibration damper is arranged between the fan and the viscous coupling and dampens and/or decouples vibrations acting between the fan and the viscous coupling.

### BACKGROUND OF THE INVENTION

1. Field of the Invention

The invention relates to a drive system of an engine cooling system in a motor vehicle, the cooling system including a radiator, an internal combustion engine and a fan, which is driven by a driveshaft of the internal combustion engine, which cools the engine cooling medium, and which is arranged between the radiator and the internal combustion engine. The drive system has a viscous coupling and a vibration damper which are both arranged between the internal combustion engine and the fan, that is to say the viscous coupling and vibration damper are directly or indirectly operatively connected to the internal combustion engine and to the fan. The vibration damper serves to ensure damping and/or decoupling of the vibrations acting between the driveshaft-side output of the internal combustion engine and the fan.

2. Description of the Related Art

DE 2007001921 U1 discloses a drive system for the engine cooling system for heavy motor vehicles, which drive system has a rotary vibration damper arranged on the driveshaft between a viscous coupling and an engine which drives the driveshaft. The rotary vibration damper restricts the wear of the components of the drive system, of the bearing arrangement of the fan and of the gearing to a level arising solely from normal frictional wear.

### SUMMARY OF THE INVENTION

An object of the present invention is to provide a drive system of the engine cooling system for motor vehicles such that a reduction in the engine-induced noise emissions of fans can be realized in a simple and inexpensive manner. Furthermore, it is an object of the invention, despite the implementation of means for reducing the engine-induced noise emissions, to ensure the provision of a drive system which is as compact as possible with regard to the axial structural length of the arrangement.

The object of the present invention is achieved in that a vibration damper is arranged between the fan and a viscous coupling and decouples vibrations acting between the fan and the viscous coupling.

According to an embodiment of the present invention, the vibration damper is arranged between the fan and the viscous coupling and, at this location, dampens the vibrations acting between the fan and the viscous coupling. The arrangement of the vibration damper in the connecting region of the fan and the viscous coupling allows the vibration damper to be designed so as to be optimized with regard to its requirements for strength and durability, and to minimize costs. A first connecting side of the vibration damper comprises only the fan. Accordingly, the strength demanded of the vibration damper is correspondingly low because, at one end side, the only torque-influencing mass acting is that of the fan itself. In the prior art, the damping element is arranged between the viscous coupling and the driveshaft which drives said viscous coupling. As such, the vibration damper must furthermore accommodate forces resulting from the rotating mass of the viscous coupling, of parts of the driveshaft, and if appropriate of further components arranged between the driveshaft and the fan. Since the vibration damper according to the invention is “relieved of load” with regard to the lower forces to be accommodated, the vibration damper can be designed in a more targeted manner for the vibration-damping function. The vibration damper with its elastic element acts primarily as a body-borne sound vibration damper, such that the transmission of body-borne sound between the engine and the fan is eliminated or at least considerably reduced. This is associated with a reduction in noise emissions by the fan.

The viscous coupling is preferably regulated in a temperature-dependent fashion and can be varied in terms of its action for example by a bimetal or an electrical/electronic input variable. Below a certain temperature threshold, the viscous coupling is open, and the maximum rotational speed of the fan is thereby limited. For example, in response to an increase in the temperature, the bimetal regulates the action of the viscous coupling and couples the latter into a second state in which the fan rotational speed then corresponds at most to the corresponding speed transformation of the engine rotational speed. Instead of a bimetal or other thermal element, the regulation may also be realized by electrical or electronic actuation of the viscous coupling. As a result of the temporary decoupling and the associated decrease in rotational speed of the fan, the energy expenditure with regard to the rotational movement of the fan is reduced.

In a preferred embodiment, the vibration damper is designed as a connecting element connecting the fan and viscous coupling. Accordingly, the vibration damper not only performs its vibration damping function but also acts as a connector between the fan and the viscous coupling. This configuration has the advantage that the vibration damper may be designed for example as a cohesively connected or detachably fastened constituent part of the fan and/or a cohesively connected or detachable constituent part of the viscous coupling. The mounting of the vibration damper on the rest of the drive system is simplified, in particular, if the vibration damper is a detachable or cohesively connected constituent part of the fan. Provision may also be made for an existing drive system to be retrofitted by exchanging a conventional fan with a fan according to the invention which is provided with a vibration damper.

Geometric changes to the fan/viscous coupling interface arising from the provision of a vibration damper may advantageously be eliminated or minimized by designing the fan such that the fan-vibration damper assembly has flange points (interfaces) to the viscous coupling which are similar or identical to those of a conventional fan.

Here, it is advantageous for the vibration damper to have parallel rigid and elastic layers arranged one after the other in the axial direction.

If permitted by the installation space in the axial direction, provision may alternatively be made for an existing fan to be equipped through the interposition of a vibration damper according to the invention which corresponds both to the fan interface and also to the viscous coupling connecting point.

In a further embodiment, the vibration damper is connected to the fan in a cohesive and/or positively locking manner. In particular, a cohesive connection of the vibration damper to the fan allows provision of an effective fan-vibration damper assembly which simultaneously takes up minimal installation space. The cohesive connection may be realized by an adhesive bond or vulcanization of the vibration damper onto the fan.

In a further embodiment, the vibration damper is formed in the shape of a ring and/or in the manner of a hollow cylinder, wherein in the fully assembled state of the vibration damper, at least regions of the viscous coupling and/or at least regions of the driveshaft which leads to the viscous coupling are surrounded and/or enclosed in the central recess of the vibration damper. Because the vibration damper is formed in the shape of a ring and/or in the manner of a hollow cylinder and the central recess of the vibration damper serves for receiving regions of the viscous coupling, it is possible for damping of the fan wheel to be ensured with compact dimensioning.

The vibration damper has for example a ring width which corresponds at most to the inner radius of the central recess or at most to ¾, ⅗, ½, ⅖ or at most ¼ of the inner radius of the central recess. Here, the ring width is to be understood to be the radial wall thickness of the vibration damper which is formed in the shape of a ring and/or in the manner of a hollow cylinder, i.e., the difference between the inner and outer radii of the circular ring. Such a ring-shaped vibration damper whose central recess is dimensioned to be larger than or equal to the ring width makes it possible to provide a vibration damper which is of adequate strength and which provides adequate damping.

With regard to the dimensions of the fan, the ratio of the radius of the fan to the inner radius of the central recess of the vibration damper (central recess) preferably amounts to at most 25:1. In further embodiment, the ratio is preferably at most 14:1, preferably at most 9.5:1, preferably at most 8.5:1, and particularly preferably at most 7.5:1.

This means that the vibration damper is arranged relatively far from the center proceeding from the fan radius, and therefore adequate space for accommodating further elements of the drive train is available in the central recess of the vibration damper. Simultaneously, the material requirement for the vibration damper to ensure the strength thereof can be kept low. Also, the forces which act at the location far from the center and which are to be accommodated by the damping element are lower than in the case of an arrangement of the vibration damper close to the center.

A further advantageous embodiment is one in which the ring depth of the vibration damper corresponds at most to the ring width, preferably at most to ¾ of the ring width, particularly preferably to at most one half of the ring width of the vibration damper. As a result of the fact that the vibration damper is arranged relatively far from the center as a circular ring, its axial connecting surface has a relatively large surface area, such that to realize the required strength and durability of the vibration damper, only a small ring depth and therefore only a small installation space requirement in the axial direction is required to its further material components/connecting partners which adjoin it in the axial direction.

It is preferable for the vibration damper to be constructed from at least two parts and, here, to comprise at least one rigid connecting element and at least one elastic damping element. Here, the connecting element connects the vibration damper to the viscous coupling, and thereby forms a suitable counterbearing for providing a connection of the vibration damper and the viscous coupling, for example using detachable fastening elements such as screws. The elastic damping element is preferably cohesively connected at one end side to the connecting element and preferably cohesively connected at the other side to the fan, such that the damping element performs the damping function of the vibration damper. In a further preferred embodiment, the damping element is formed in a sandwich-like manner between a first connecting element for connecting the vibration damper to the viscous coupling and a second connecting element for connecting the vibration damper to the fan. Here, the second connecting element can serve as a counterbearing for fastening elements for fastening a fan to the vibration damper.

Alternatively, the elastic damping element is cohesively connected to the fan, such that the second connecting element for connecting the vibration damper to the fan can be omitted.

The structure, which comprises at least two elements, of the vibration damper may furthermore be designed such that the damping element comprises at least two ring segments which are spaced apart from one another, wherein the intermediate space between the ring segments is, at least in regions, free and/or provided with an element which has a different elasticity than the damping element. The free spaces or the intermediate spaces with the element of a different elasticity make it possible to targetedly influence the vibration-damping characteristics of the vibration damper. For example, the vibration damper is provided with at least one damping element region which can be broken out of the vibration damper by predetermined breaking points. It is advantageous here that an adaptation of the damping characteristics can be carried out after the manufacturing of the damping element. It is also possible for both the connecting element and the damping element to be formed as ring segments, which are for example aligned congruently or with an offset with respect to one another.

According to a further aspect of the invention, the connecting element is provided with at least one fixing element receiving bore which adjoins a fixing element receiving recess in the damping element. The fixing element receiving recess is preferably aligned at right angles with respect to the fixing element receiving bore. As fixing element, use is made for example of a screw whose screw shank is passed through the fixing element receiving bore and whose screw head is countersunk and/or can be at least partially received in the fixing element receiving recess at the level of the damping element.

In this connection, it is particularly advantageous for the geometry and/or the dimensioning of the fixing element receiving recess and the geometry and/or the dimensioning of the fixing element to be received in the fixing element receiving recess to be configured such that, at least in the fully assembled state, the damping element makes contact at least in regions with the fixing element in the region of the fixing element receiving recess.

If a screw is used as the fixing element, a screw head contacts at least in regions the damping element which delimit the fixing element receiving recess. Aside from the maximum space utilization afforded by this measure—as a result of the fact that a maximum surface area is provided for the damping element for contact with further elements and at the same time only a space necessary for receiving the screw heads is required—a further advantage can be seen in the fact that the contact of the screw head against the damping element simultaneously secures the screw so as to prevent it from being unscrewed. In particular, screws on moving parts have a tendency to loosen with progressive operating duration, and therefore such an exertion of load on the screw head by the damping element (for example clamping) can reduce this risk.

In a specific embodiment, a hexagon socket screw is used and a screw head surface thereof makes contact with the inner wall surface or raised regions of the inner wall surface. The damping element therefore both performs a damping function and also performs the function of securing the screw connection.

Furthermore, it is advantageous for the connecting element and the damping element to be arranged parallel and offset relative to one another in the axial direction. It is for example possible for both the connecting element and also the damping element to each be in the form of a circular ring, which circular rings are aligned concentrically and with an axial offset and are connected to one another at the ring surfaces. Here, the connecting and damping elements lie in separate planes which are parallel to and adjoin one another and which extend at right angles to the axial direction.

In a preferred embodiment of the invention, the vibration damper is designed with a ring-shaped and/or hollow cylindrical form, wherein the ratio of fan outer diameter to axial depth (thickness) lies in the range from 7:1 to 15:1, preferably in the range from 8:1 to 10:1.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a schematic illustration of a connection of a fan to an internal combustion engine according to the prior art;

FIG. 2 is a schematic illustration of an embodiment of the present invention of an arrangement of a vibration damper on a fan;

FIG. 3 is a schematic illustration of a further embodiment, in which the vibration damper is arranged on a viscous coupling;

FIG. 4 is a schematic illustration of an alternative embodiment in which the fan is connected directly to the viscous coupling via the vibration damper;

FIG. 5 is a schematic illustration of an alternative embodiment in which the viscous coupling is arranged on a side of the fan that faces the radiator;

FIG. 6 is a schematic illustration of an embodiment in accordance with FIG. 5, but with a detachable connection of the vibration damper to the fan;

FIG. 7a is a schematic sectional illustration of the connection of the viscous coupling to the vibration damper in detail, with the viscous coupling and vibration damper spaced apart from one another (in a pre-assembled state);

FIG. 7b is a schematic sectional illustration of the embodiment of FIG. 7a, with the viscous coupling and vibration damper assembled (in a fully assembled state);

FIG. 8 is a schematic sectional illustration of an embodiment according to FIG. 6; and

FIG. 9 is a schematic front view of a fan provided with a vibration damper.

### DETAILED DESCRIPTION OF THE PREFERRED EMBODIMENTS

According to FIG. 1, a drive system 1 of the engine cooling arrangement for a motor vehicle according to the prior art includes a radiator 2, an internal combustion engine 3, and a fan 5 which is driven by a driveshaft 4 of the internal combustion engine 3 and which is arranged between the radiator 2 and the internal combustion engine 3. Furthermore, a viscous coupling 6 is arranged between the internal combustion engine 3 and the fan 5. The viscous coupling can be indirectly thermally or directly electronically/electrically actuated and adjusted in terms of its torque and/or transmission behaviour, or at least limited with regard to the transmission of the maximum rotational speed.

Arranged between the viscous coupling 6 and the internal combustion engine 3 is a vibration damper 7 which dampens and/or decouples vibrations between the driveshaft-side output A of the internal combustion engine 3 and the fan 5.

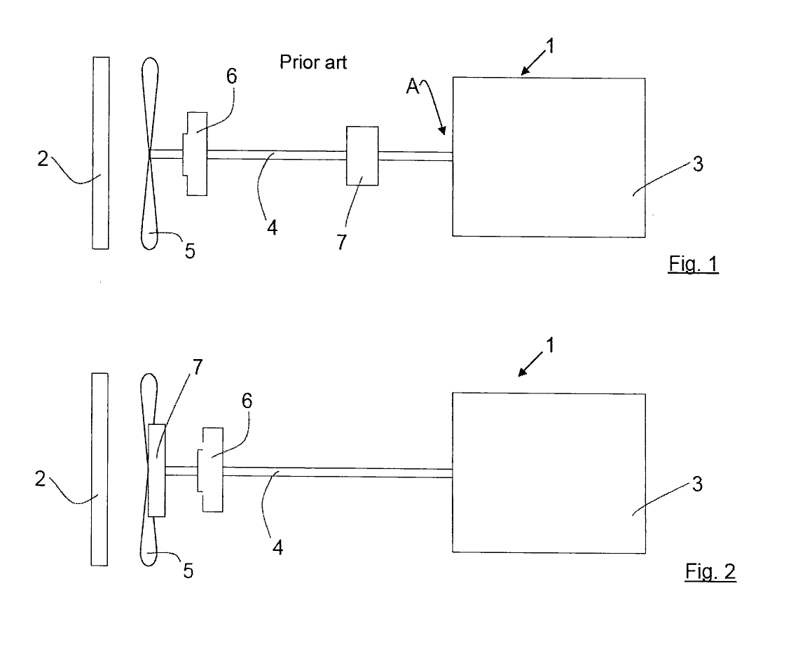

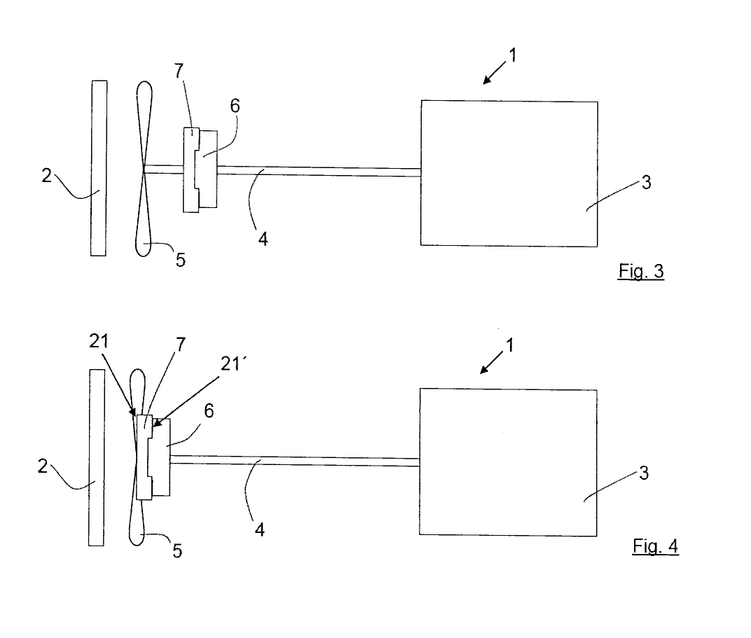

In a first embodiment of the present invention shown in FIG. 2, the vibration damper 7 is arranged between the fan 5 and the viscous coupling 6. The vibration damper 7 is directly fastened to the fan 5 and/or incorporated therein in a cohesive or positively locking fashion. In an alternative embodiment shown in FIG. 3, the vibration damper 7 is directly fastened to the viscous coupling 6. In a further embodiment shown in FIG. 4, the vibration damper 7 is directly connected at a first end side 21 to the fan 5 and at an opposite end side 21′ to the viscous coupling 6. In particular in the embodiment as per FIG. 4, the vibration damper 7 acts as a connecting element between the fan 5 and viscous coupling 6.

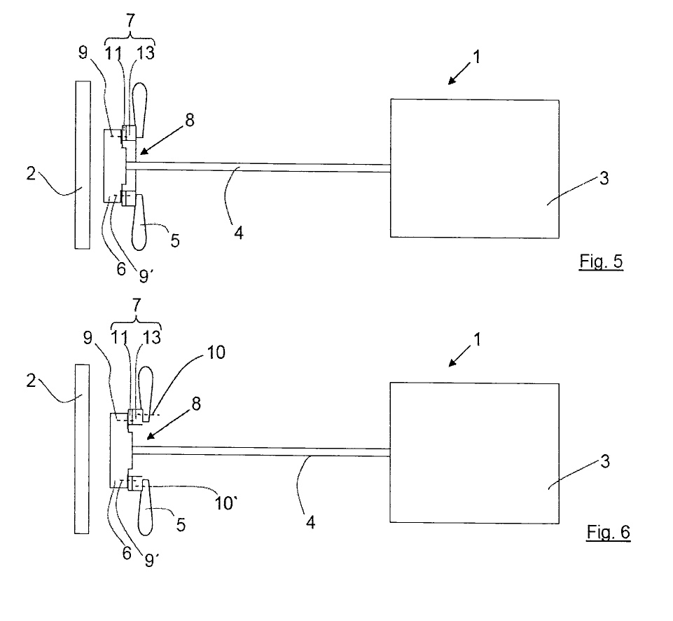

In yet a further embodiment shown FIGS. 5 to 8, the vibration damper 7 and the fan 5 are provided with a central recess 8 through which at least regions of the driveshaft 4 and/or of the viscous coupling 6 extend. It is hereby made possible for the viscous coupling 6 to be arranged on that side of the fan 5 which faces the radiator 2.

Here, the vibration damper 7 is particularly preferably formed in the shape of a ring and/or in the manner of a hollow cylinder, such that at least regions of the viscous coupling 6 and/or at least regions of the drive shaft 4 which leads to the viscous coupling 6 are surrounded by the central recess 8 in the fully assembled state.

In FIG. 5, the fan 5 is formed in one piece with and/or connected in a positively locking manner to the vibration damper 7 and connected to the viscous coupling 6 by connecting elements 9, 9′ (for example screws or rivets). In contrast, FIG. 6 includes further connecting elements 10, 10′ in addition to the connecting elements 9, 9′ for connecting the vibration damper 7 to the viscous coupling 6. The further connecting elements 10, 10′ detachably connect the vibration damper 7 to the fan 5. In FIGS. 5 to 8, the viscous coupling 6 is formed as the element closest to the radiator 2. An advantage of this embodiment is that the viscous coupling is subjected to a cooling action. In the arrangements according to FIGS. 5 to 8, the operative connection is as follows: internal combustion engine 3, driveshaft 4, viscous coupling 6, vibration damper 7, fan wheel 5. Therefore, the viscous coupling 6 and the vibration damper 7 are arranged between the internal combustion engine 3 and the fan 5 in these embodiments.

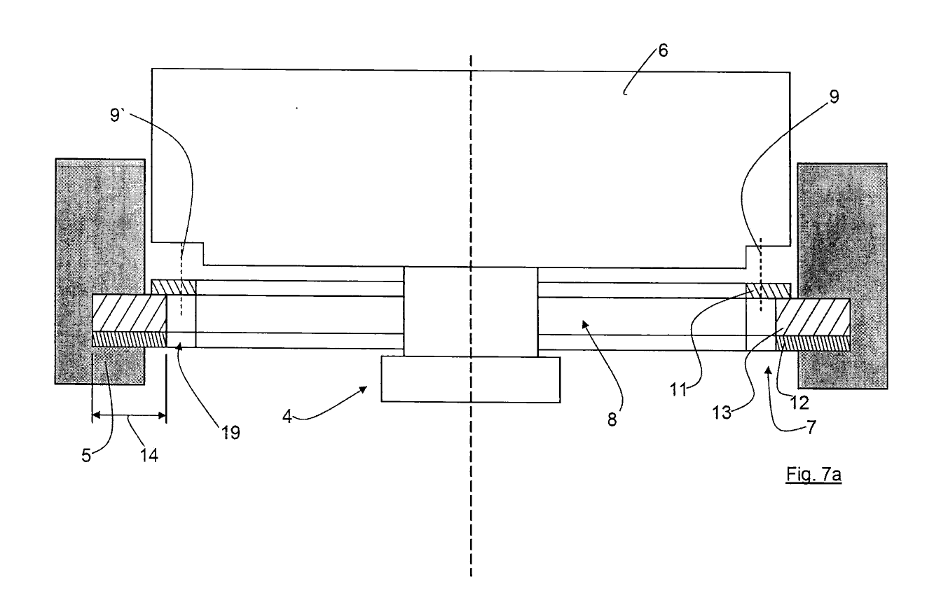

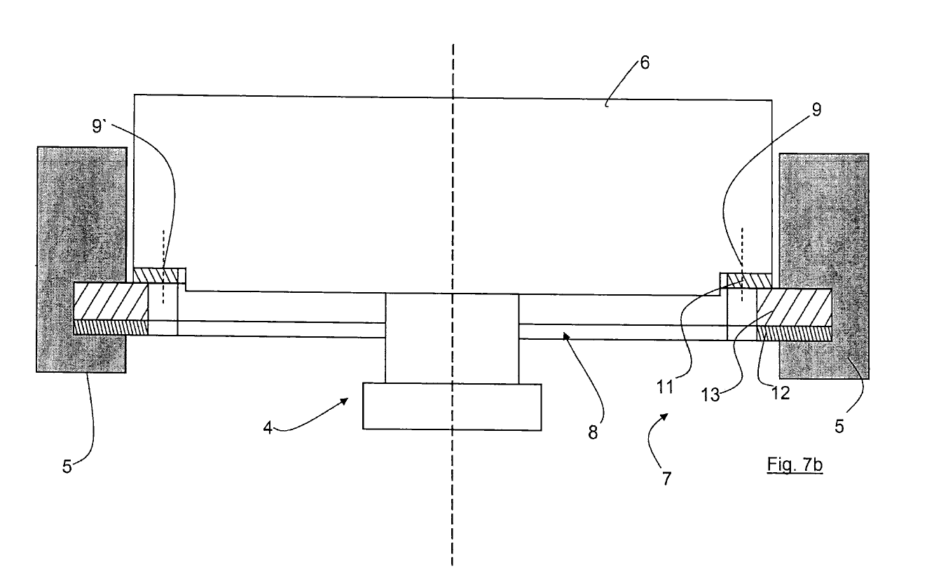

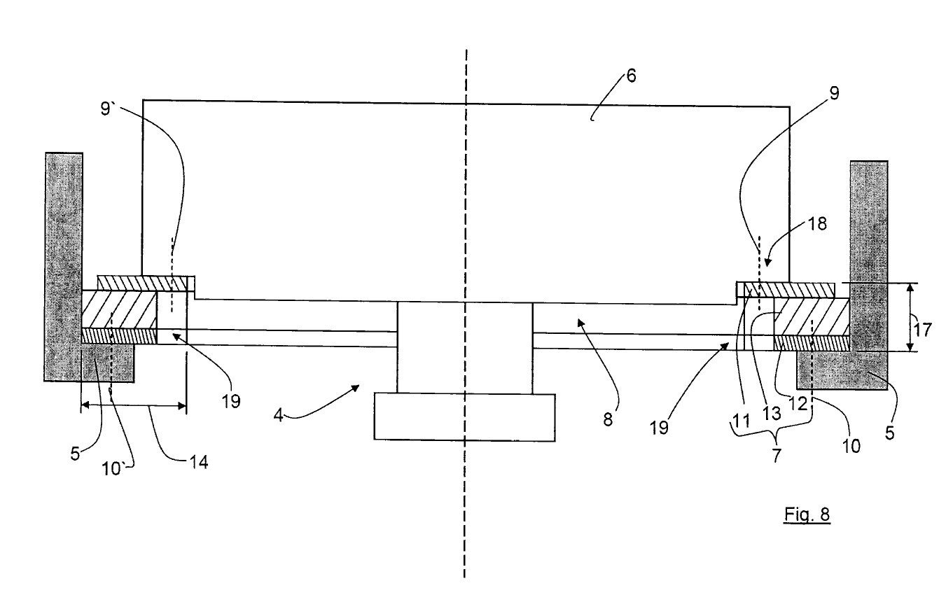

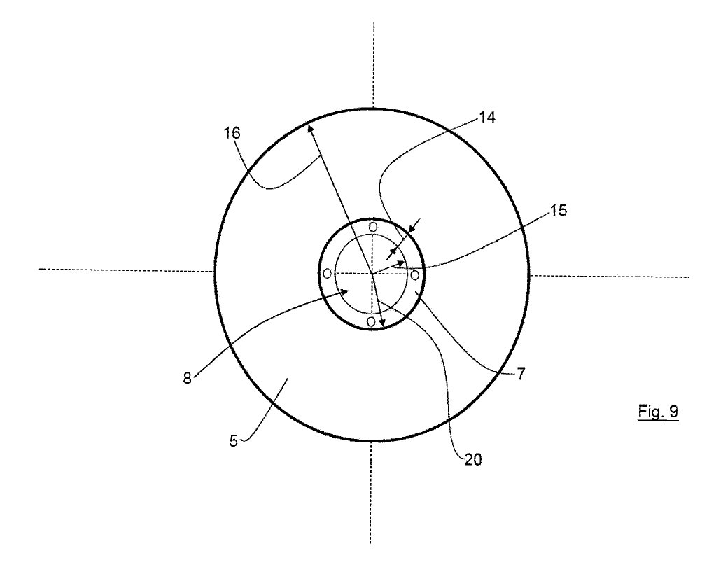

Details of the connection of the viscous coupling 6 to the fan 5 are illustrated in FIGS. 7a, 7b and 8. Here, the illustrated vibration damper 7 comprises three parts 11, 12, 13, of which two are provided as connecting elements 11, 12 and one is provided as an elastic damping element 13. Here, the damping element 13 is provided on two opposite sides, in a sandwich-like configuration, with in each case one connecting element 11, 12. In the illustrated embodiment in FIGS. 7a, 7b and 8, all three elements 11, 12, 13 are formed as mutually concentric circular rings which are connected to one another in layered fashion in the axial direction. Here, the elements 11, 12, 13 need not form a complete circular ring, such as is illustrated, but rather may also be formed merely as circular ring segments through the provision of discontinuities. In the case of the connecting or damping elements 11, 12, 13 being of ring-segment-like form, it may be provided that the intermediate spaces of the ring segments are filled out at least in regions by a further element (not illustrated), wherein said further element has a different elasticity than the damping element 13.

In the embodiment of FIGS. 7a and 7b, the damping element 13 and the connecting element 12 are connected to the fan 5 in a non-detachable manner, for example by an injection-moulding process. The connecting element 11, which is connected exclusively via the cohesive connection to the damping element 13 and therefore indirectly to the fan 5, serves as a connecting interface between the fan-vibration damper assembly 5, 7 and the viscous coupling 6. In FIG. 7a, the viscous coupling 6 is illustrated in a position in which it is spaced apart from the assembly 5, 7. In FIG. 7b of the drawing, the fan-vibration damper assembly 5, 7 is detachably connected to the viscous coupling by the connecting elements 9, 9′ (final assembly).

FIG. 8 shows an alternative to the embodiment of FIG. 7b, with two substantial differences. First, the fan wheel 5 is connected to the connecting element 12 of the vibration damper 7 detachably by the connecting elements 10, 10′. In addition, the fan 5 is cohesively connected exclusively to the connecting element 12. An embodiment may self-evidently also comprise only one of these two differences.

Preferred dimensions of the fan-vibration damper assembly 5, 7 will be explained on the basis of FIG. 9. In the embodiment according to the invention, the vibration damper 7 has a ring width 14 which amounts at most to the inner radius 15 of the central recess 8 or at most to ¾, ⅗, ½, ⅖ or at most ¼ of the inner radius 15 of the recess 8 of the vibration damper 7.

It is furthermore advantageous for the ratio of the outer radius 16 of the fan 5 to the inner radius 15 of the vibration damper 7 to be at most 25:1, preferably at most 14:1, preferably at most 9.5:1, preferably at most 8.5:1 or particularly preferably at most 7.5:1.

In a further embodiment, as seen in the juxtaposition of FIGS. 8 and 9, the ring depth 17 of the vibration damper 7 corresponds at most to the ring width 14 of the vibration damper 7, at most to ¾ of the ring width 14, preferably at most to one half of the ring width 14 of the vibration damper 17.

As can be seen in FIGS. 7a, 7b and 8, the connecting element 11 may comprise at least one fixing element receiving bore 18 which adjoins a fixing element receiving recess 19 in the damping element 13 and the further connecting element 12. The fixing element receiving bore 18 is only indirectly indicated in the Figures by the connecting element 9, 9′ illustrated by dashed lines. In contrast, the fixing element receiving recess 19 can be seen as a material recess in the section plane as a discontinuity in the region which forms the ring width 14.

In a further embodiment, the vibration damper 7 is of ring-shaped and/or hollow cylindrical form, and here, a ratio of the outer radius 20 of the vibration damper 7 to the axial depth (ring depth 17) of the vibration damper 7 lies in the range from 7:1 to 15:1, preferably in the range from 8:1 to 10:1.

Advantageous absolute dimensions for the vibration damper 7 are as follows:

for the ring width 14: 10 to 80 mm, preferably 20 to 40 mm;

for the inner radius 15: 50 to 150 mm, preferably 70 to 120 mm;

for the outer radius 20: 90 to 200 mm, preferably 90 to 150 mm;

for the ring depth 17: 10 to 50 mm, preferably 10 to 25 mm.

The diameter of the fan 5 may amount to between 150 and 950 mm, preferably between 600 and 950 mm. The advantages of the invention are brought to bear primarily in the case of fan diameters of 600 to 950 mm, because in the case of such diameters a greater fan mass and greater lever forces act on the damping element 13, and the required strength and sound damping characteristics can be ensured by the design according to the invention of the vibration damper 7 together with its damping element 13. Fan diameters of greater than 950 mm are basically also practicable in the design according to the invention.

For the advantageous ratios of the dimensions of the vibration damper 7 and of the fan 5, the following ratio ranges are expedient:

ratio of ring width 14 to inner radius 15: between 1.00 and 0.05;

ratio of radius 16 of the fan 5 to inner radius 15: between 2.5 and 25, preferably between 2.5 and 9.5;

ratio of outer radius 20 to ring depth 17: between 7.0 and 15.0.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A drive system in a cooling system in a motor vehicle, the cooling system including a fan and a radiator for cooling a cooling medium of an internal combustion engine, the fan being driven by a drive shaft of the internal combustion engine and being arranged between the internal combustion engine and the radiator, the drive system comprising:
a viscous coupling; and
a vibration damper comprising an elastic element,
the viscous coupling and the vibration damper being arranged between the internal combustion engine and the fan, the vibration damper being arranged between the viscous coupling and the fan to at least one of dampen and decouple vibrations acting between the fan and the viscous coupling.

2. The drive system of claim 1, wherein the vibration damper is a connecting member connecting the fan and the viscous coupling.

3. The drive system of claim 1, wherein the vibration damper is detachably connected to at least one of the fan and the viscous coupling.

4. The drive system of claim 1, wherein the vibration damper is connected to the fan in a cohesive or positively locking manner.

5. The drive system of claim 1, wherein the vibration damper is one of a ring and a hollow cylinder and defines a central recess, wherein, in the fully assembled state, at least one of a portion of the viscous coupling and a portion of the driveshaft which leads to the viscous coupling is received in the central recess of the vibration damper.

6. The drive system of claim 5, wherein the vibration damper has a ring width that is at most a radius of the central recess, the ring width being a difference between the outer radius and the inner radius of the one of the ring and the hollow cylinder.

7. The drive system of claim 5, wherein a ratio of a radius of the fan to the radius of the central recess of the vibration damper is at most 8.5:1.

8. The drive system of claim 5, a ring depth of the vibration damper in an axial direction of the fan is at most one half of the ring width, the ring depth being a difference between the outer radius and the inner radius of the one of the ring and the hollow cylinder.

9. The drive system of claim 1, wherein the vibration damper is constructed from at least two parts and comprises at least one rigid connecting element and at least one elastic damping element.

10. The drive system of claim 9, wherein at least one of the at least one connecting element and the at least one damping element comprises at least two ring segments spaced apart from one another, wherein the intermediate space between the ring segments is at least partially one of free and provided with an element having a different elasticity than the at least one damping element.

11. The drive system of claim 9, wherein the at least one connecting element comprises at least one fixing element receiving bore which adjoins a fixing element receiving recess in the at least one damping element.

12. The drive system of claim 11, wherein at least one of the fixing element receiving recess and a fixing element to be received in said fixing element receiving recess is arranged and dimensioned such that, at least in the fully assembled state, the at least one damping element contacts at least in regions the fixing element at the fixing element receiving recess.

13. The drive system of claim 9, wherein the at least one connecting element and the at least one damping element are arranged parallel to one another and offset relative to one another in the axial direction.

14. A vibration damper for decoupling vibrations in a drive system for a fan of a cooling system in a motor vehicle, the cooling system including the fan and a radiator for cooling a cooling medium of an internal combustion engine, the fan being driven by a drive shaft of the internal combustion engine and being arranged between the internal combustion engine and the radiator, the drive system comprising the vibration damper and a viscous coupling, the vibration damper comprising:
at least one rigid connecting element and at least one elastic damping element,
the vibration damper being arranged between the viscous coupling and the fan to at least one of dampen and decouple vibrations acting between the fan and the viscous coupling.

15. The vibration damper of claim 14, wherein the vibration damper is one of a ring and a hollow cylinder and defines a central recess, wherein, in the fully assembled state, at least one of a portion of the viscous coupling and a portion of the driveshaft which leads to the viscous coupling is receivable in the central recess of the vibration damper, and wherein a ratio of an outer radius to ring depth lies in the range from 8:1 to 10:1.

16. The drive system of claim 6, wherein the ring width is at most ⅖ of the inner radius of the central recess.
